(19) United States
(12) Patent Application Publication
(10) Pub. No.: US 2006/0160526 A1
(43) Pub. Date: Jul. 20, 2006

(54) Communication apparatus and method for sounding dual tone multiple frequency sound corresponding to phone numbers

(76) Inventors: Zhi-Jia Hung, Taichung City (TW); Wen-Wei Hsiao, Taipei City (TW)

Correspondence Address: HARNESS, DICKEY & PIERCE, P.L.C., P.O. BOX 8910, RESTON, VA, 20195, US

(21) Appl. No.: 11/037,082

(22) Filed: Jan. 19, 2005

(51) Int. Cl. H04B 7/00; H04L 12/58

(52) U.S. Cl. 455/412.1; 455/66.1

(57) ABSTRACT

A mobile communication apparatus is provided. The mobile communication apparatus includes an input device, a storage device, a processing device and a sounding device. The storage device stores a plurality of phone numbers and a plurality of dual tone multiple frequency (DTMF) sound data. The processing device is electrically connected to the input device and the storage device for outputting a phone number, and the sounding device is electrically connected to the processing device for sounding a DTMF sound corresponding to the phone number according to the DTMF sound data.

### FIELD OF THE INVENTION

The present invention relates to the mobile communication apparatus, and more particular to the mobile communication apparatus and method for sounding the dual tone multiple frequency sounds corresponding to phone numbers.

### BACKGROUND OF THE INVENTION

At present, there are still distinct differences between the charge rates for the local phone system (in particular, the wire communication system) and the mobile communication system (in particular, the wireless communication system, such as the personal digital assistant (PDA), and the mobile phone etc.). Therefore, if it is allowable, most users will use the local phone system rather than the mobile communication system, so as to save the relevant cost. However, in practice, since the phone numbers are usually stored in the mobile communication system, it is necessary to find the desired phone number out from the contact list of the mobile communication device first and then to memory it, write it down or directly dial the phone number in the local phone system by hands accordingly. However, it's easy to make mistakes during the processes of memorizing, writing down or manually dialing the phone numbers. Please refer to FIG. 1, which shows a flow chart of the dialing process in the prior art. As shown in FIG. 1, when the steps of memorizing, writing down and manually dialing the phone numbers are performed, it's easy to make mistakes. Therefore, the apparatus and method avoiding the general steps of memorizing, writing down and manually dialing phone numbers are desired.

As above-mentioned, in order to avoid the mistakes resulted from the steps of memorizing, writing, and manually dialing, a mobile communication apparatus capable of sounding the dual tone multiple frequency sounds corresponding to phone numbers itself and the method for using the same are provided in the present invention.

### SUMMARY OF THE INVENTION

In accordance with an aspect of the present invention, a mobile communication apparatus is provided. The mobile communication apparatus includes an input device, a storage device, a processing device and a sounding device. The storage device stores a plurality of phone numbers and a plurality of dual tone multiple frequency (DTMF) sound data. The processing device is electrically connected to the input device and the storage device for outputting a phone number, and the sounding device is electrically connected to the processing device for sounding a DTMF sound corresponding to the phone number according to the DTMF sound data.

Preferably, the processing device receives a command from the input device to search for the phone number from the plurality of phone numbers.

Preferably, the phone number includes an area code and a communicating number.

Preferably, the mobile communication apparatus further includes a positioning device electrically connected to the processing device.

Preferably, the positioning device transmits a signal representing a location of the mobile communication apparatus to the processing device, and then the processing device determines whether a local area code for the location is the same as the area code of the phone number; if yes, the specific DTMF sound only includes a first DTMF sound part corresponding to the communicating number of the phone number, and if not, the DTMF sound includes the first DTMF sound part and a second DTMF sound part corresponding to the area code of the phone number.

Preferably, the positioning device receives positional information from a global position system (GPS) and then transmits the signal to the processing device accordingly.

Preferably, the processing device receives a second command from the input device according to an instruction from a user, and then determines whether the sounding device sounds the DTMF sound with the second DTMF sound part.

Preferably, the processing device receives a signal representing a location of the mobile communication apparatus from a telecommunication station, and then determines whether a local area code for the location is the same as the area code of the phone number; if yes, the DTMF sound only comprises a first DTMF sound part corresponding to the communicating number of the phone number, and if not, the DTMF sound comprises the first DTMF sound part and a second DTMF sound part corresponding to the area code of the phone number.

In accordance with another aspect of the present invention, a method for sounding a dual tone multiple frequency (DTMF) sound for a mobile communication apparatus is provided. The method includes steps of receiving a first command, finding out a phone number corresponding to the first command and sounding the DTMF sound corresponding to the phone number.

Preferably, the phone number includes an area code and a communicating number.

Preferably, the method further includes a step of determining whether a local area code is the same as the area code of the phone number according to a signal representing a location of the mobile communication apparatus; if yes, the DTMF sound only includes a first DTMF sound part corresponding to the communicating number of the phone number, and if not, the DTMF sound includes the first DTMF sound part and a second DTMF sound part corresponding to the area code of the phone number.

Preferably, the signal is provided by a global position system (GPS).

Preferably, the signal is provided by a telecommunicating station.

Preferably, the method further includes steps of receiving a second command from an input device according to a user's instruction and determining whether the DTMF sound includes the second DTMF sound part according to the second command.

In accordance with another aspect of the present invention, a method for sounding a dual tone multiple frequency (DTMF) sound for a mobile communication apparatus is provided. The method includes steps of receiving a command, receiving a positional information, searching a database according to the command and the positional information so as to search for a phone number and sounding the DTMF sound corresponding to the DTMF sound data.

Preferably, the phone number includes an area code and a communicating number.

Preferably, the positional information is provided by a positioning device.

Preferably, the positioning device is a global position system (GPS).

Preferably, the positional information is provided by a telecommunicating station.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a flow chart of the dialing process in the prior art; and

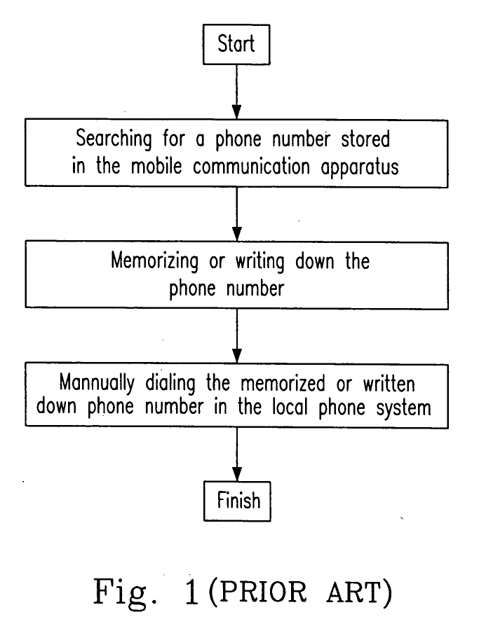

FIG. 2 is a schematic view of the mobile communication apparatus according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

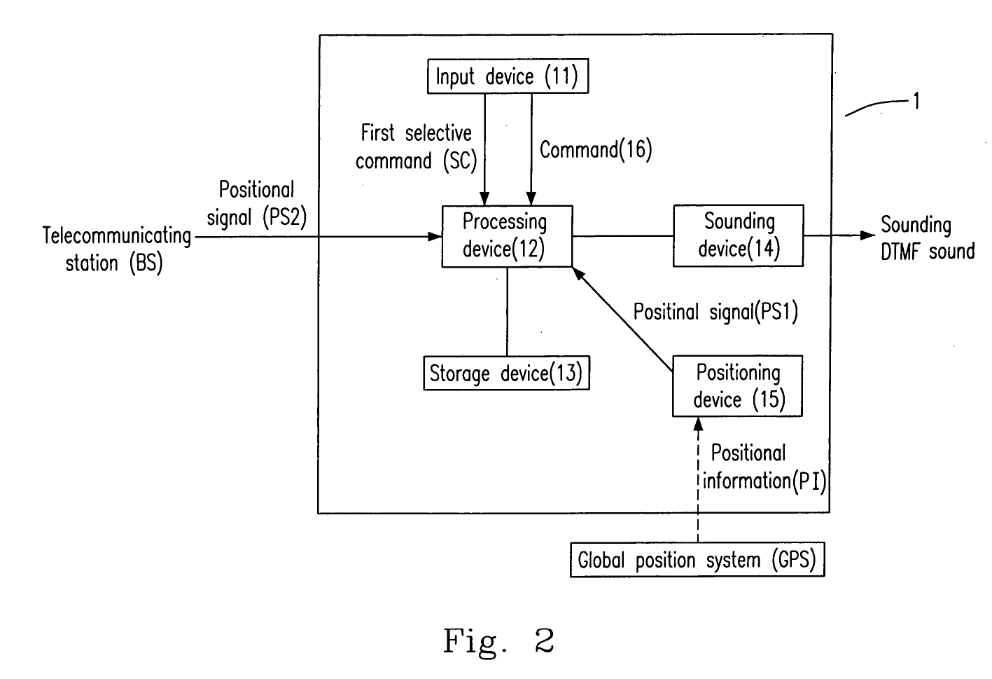

Please refer to FIG. 2, which shows a schematic view of the mobile communication apparatus according to a preferred embodiment of the present invention. As shown in FIG. 2, the mobile communication apparatus 1 includes the input device 11, the processing device 12, the storage device 13, the sounding device 14, and the positioning device 15. After a user (not shown) instructs a first selective command SC to the processing device 12 by the input device 11, the processing device 12 searches for the plurality of phone numbers, which are stored in the storage device 13, so as to find out a phone number in response to the selective command SC and the DTMF sound information corresponding to the found phone number. After that, the sounding device 14 sounds the DTMF sound corresponding to the found phone number under the control of the processing device 12 according to the DTMF sound information.

The positioning device 15 is electrically connected to the processing device 12 and receives the positional information PI from a global position system (GPS). After receiving the positional information PI, the positioning device 15 transmits a positional signal PS1 representing the location of the mobile communication apparatus 1 to the processing device 12. It should be noted that the positional information PI might be provided by other apparatus or systems. Furthermore, in addition to receiving the positional signal PS1 from the positioning device 15, the processing device 12 may receive a positional signal PS2 representing the location of the mobile communication apparatus 1 provided by the telecommunicating station BS. However, in practice, the found phone number includes two parts, the area code and the communicating number, and the DTMF sound might include a first DTMF sound part and a second DTMF sound part, which both respectively correspond to the communicating number and the area code of the found phone number.

After receiving the positional signals PS1 or PS2, the processing device 12 determines whether a local area code for the location of the mobile communication apparatus 1 is the same as the area code of the phone number. If the local area code for the location of the mobile communication apparatus 1 is consistent with the area code of the phone number, only the first DTMF sound part of the DTMF is sounded by the sounding device 14 under the control of the processing device 12. In addition, if the local area code for the location of the mobile communication apparatus 1 is not consistent with the area code of the phone number, the first DTMF sound part and the second DTMF sound part are sounded by the sounding device 14 under the control of the processing device 12. Furthermore, it is also possible that the user (not shown) directly instructs a command 16 to the processing device 12 via the input device 11, so as that the sounding device 14 only sounds the first DTMF sound part of the DTMF sound or sounds both the first DTMF sound part and the second DTMF sound part under the control of the processing device 12.

In view of the aforesaid, the present invention provides the mobile communication apparatus capable of sounding the dual tone multiple frequency (DTMF) sounds corresponding to phone numbers and the method thereof. Thus, when the mobile communication apparatus of the present invention is located nearby the microphone of telephone used in the local phone system, once the mobile communication apparatus of the present invention sounds the DTMF sound of the desired phone number, the dialing process of the local phone system will be carried out accordingly. Therefore, when the user tries to use the local phone system to dial the phone numbers stored in the database of the -mobile communication apparatus, the mistakes resulted form the processes of memorizing, writing down or manually dialing are certainly avoided, according to the present invention. Therefore, the present invention is extremely suitable for being used in the industrial production.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mobile communication apparatus, comprising:
an input device;
a storage device storing a plurality of phone numbers and a plurality of dual tone multiple frequency (DTMF) sound data;
a processing device electrically connected to said input device and said storage device for outputting a phone number; and
a sounding device electrically connected to said processing device for sounding a DTMF sound corresponding to said phone number according to said DTMF sound data.

2. The mobile communication apparatus according to claim 1, wherein said processing device receives a command from said input device to search for said phone number from said plurality of phone numbers.

3. The mobile communication apparatus according to claim 1, wherein said phone number comprises an area code and a communicating number.

4. The mobile communication apparatus according to claim 3 further comprising a positioning device electrically connected to said processing device.

5. The mobile communication apparatus according to claim 4, wherein said positioning device transmits a signal representing a location of said mobile communication apparatus to said processing device, and then said processing device determines whether a local area code for said location is the same as said area code of said phone number; if yes, said DTMF sound only comprises a first DTMF sound part corresponding to said communicating number of said phone number, and if not, said DTMF sound comprises said first DTMF sound part and a second DTMF sound part corresponding to said area code of said phone number.

6. The mobile communication apparatus according to claim 5, wherein said positioning device receives positional information from a global position system (GPS) and then transmits said signal to said processing device accordingly.

7. The mobile communicating apparatus according to claim 3, wherein said processing device receives a second command from said input device according to an instruction from a user, and then determines whether said sounding device sounds said DTMF sound with said second DTMF sound part.

8. The mobile communication apparatus according to claim 4, wherein said processing device receives a signal representing a location of said mobile communication apparatus from a telecommunicating station, and then determines whether a local area code for said location is the same as said area code of said phone number; if yes, said DTMF sound only comprises a first DTMF sound part corresponding to said communicating number of said phone number, and if not, said DTMF sound comprises said first DTMF sound part and a second DTMF sound part corresponding to said area code of said phone number.

9. A method for sounding a dual tone multiple frequency (DTMF) sound for a mobile communication apparatus, comprising steps of:
receiving a first command;
finding out a phone number corresponding to said first command; and
sounding said DTMF sound corresponding to said phone number.

10. The method according to claim 9, wherein said phone number comprises an area code and a communicating number.

11. The method according to claim 10 further comprising a step of:
determining whether a local area code is the same as said area code of said phone number according to a signal representing a location of said mobile communication apparatus; if yes, said DTMF sound only comprises a first DTMF sound part corresponding to said communicating number of said phone number, and if not, said DTMF sound comprises said first DTMF sound part and a second DTMF sound part corresponding to said area code of said phone number.

12. The method according to claim 11, wherein said signal is provided by a global position system (GPS).

13. The method according to claim 11, wherein said signal is provided by a telecommunicating station.

14. The method according to claim 9, further comprising steps of:
receiving a second command from an input device according to a user's instruction; and
determining whether said DTMF sound comprises said second DTMF sound part according to said second command.

15. A method for sounding a dual tone multiple frequency (DTMF) sound for a mobile communication apparatus, comprising steps of:
receiving a command;
receiving a positional information;
searching a database according to said command and said positional information so as to search for a phone number; and
sounding said DTMF sound corresponding to said DTMF sound data.

16. The method according to claim 15, wherein said phone number comprises an area code and a communicating number.

17. The method according to claim 15, wherein said positional information is provided by a positioning device.

18. The method according to claim 17, wherein said positioning device is a global position system (GPS).

19. The method according to claim 15, wherein said positional information is provided by a telecommunicating station.
